(19) United States
(12) Patent Application Publication
(10) Pub. No.: US 2026/0314628 A1
(43) Pub. Date: Oct. 15, 2026

(54) SERVICEABLE CANDY FLOSS MACHINE

(71) Applicant: LAI Games Pte Ltd., Singapore (SG)

(72) Inventors: Mark Joseph Easte, Singapore (SG); Shao Hui Wong, Singapore (SG)

(21) Appl. No.: 19/641,834

(22) Filed: Apr. 8, 2026

Related U.S. Application Data
(60) Provisional application No. 63/786,671, filed on Apr. 10, 2025.

(51) Int. Cl. A23G 3/10

(52) U.S. Cl. CPC A23G 3/10

(57) ABSTRACT

A candy floss machine has a housing, a candy floss processor, a candy floss processing area into which candy floss is dispensed by the candy floss processor, the processing area defined by one or more walls, a candy floss dispensing area, and a plurality of cleanable panel members removably connected to the one or more walls of the processing area. When the one or more walls of the processing area are metallic, the plurality of cleanable panel members may be removably connected thereto with one or more magnets. The plurality of cleanable panel members comprise melamine panels.

### RELATED APPLICATION DATA

This application claims priority to U.S. Provisional Application Ser. No. 63/786,671, filed Apr. 10, 2025, which prior application is incorporated by reference in its entirety herein.

### FIELD OF THE INVENTION

The present invention relates to candy floss machines.

### BACKGROUND OF THE INVENTION

The process for making cotton candy, otherwise known as candy floss, has been known since the late 1800s. Generally, this process involves heating raw sugar and then passing it through a screen to create sugar strands or “floss” elements which are captured for consumption (such as by wrapping them on a stick or paper holder).

In recent years, candy floss machines have been created which automate the process of making candy floss, allowing the process to be “self-service.” In general, these automated candy floss machines have a housing which contains the candy floss. A user simply provides payment and the floss is generated in a processing area, is placed on a stick or holder, and then moved to a dispensing area.

These machines have great advantages because they do not need to be staffed in order to operate them. For example, they can be located in a mall or other area and be used by patrons without the operator being required to hire someone to make and dispense the candy floss.

A significant problem with these machines, however, is their serviceability. For example, as candy floss is generated in the processing area, it collects on the interior walls of the processing area. Over time, the processing area becomes unsanitary due to the collection of this candy floss. This generally requires the operator to travel to the machine, open it up and then hand clean the interior of the processing area. This may involve spraying the interior and wiping it down with a liquid cleaner. Due to the sticky nature of the candy floss, this can be difficult and time consuming. Further, it is difficult to adequately clean seams, corners and other locations.

Other serviceability issues exist. For example, the raw sugar used in the candy floss making process is generally stored in containers in the housing. It can be difficult to access and fill these containers when they are empty.

### SUMMARY OF THE INVENTION

Aspects of the invention comprise an improved candy floss machine and methods of operating, including cleaning and servicing, such machines.

In one embodiment, a candy floss machine comprises a housing, a candy floss processor, a candy floss processing area into which candy floss is dispensed by the candy floss processor, the processing area defined by one or more walls, a candy floss dispensing area, and a plurality of cleanable panel members removably connected to the one or more walls of the processing area.

In one embodiment, the one or more walls of the processing area are metallic and the plurality of cleanable panel members are removably connected thereto with one or more magnets.

In one embodiment, the plurality of cleanable panel members comprise melamine panels.

In another embodiment of the invention, a method of servicing a candy floss machine comprises detaching a plurality of cleanable panel members from the walls of the candy floss processing area of a candy floss machine and washing the panels, such as in a dishwasher. The method may further comprise the step of reattaching the panels to the walls for use of the candy floss machine.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of a candy floss machine in accordance with the invention;

FIG. 2 illustrates portions of an interior area of the candy floss machine illustrated in FIG. 1;

FIG. 3 illustrates processing area of the candy floss machine of FIG. 1; and

FIG. 4 is an exploded view of the processing area of FIG. 3.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise an improved candy floss machine and methods of operating, including cleaning and servicing, such machines. In a preferred embodiment, the candy floss machine is configured as a self-service machine.

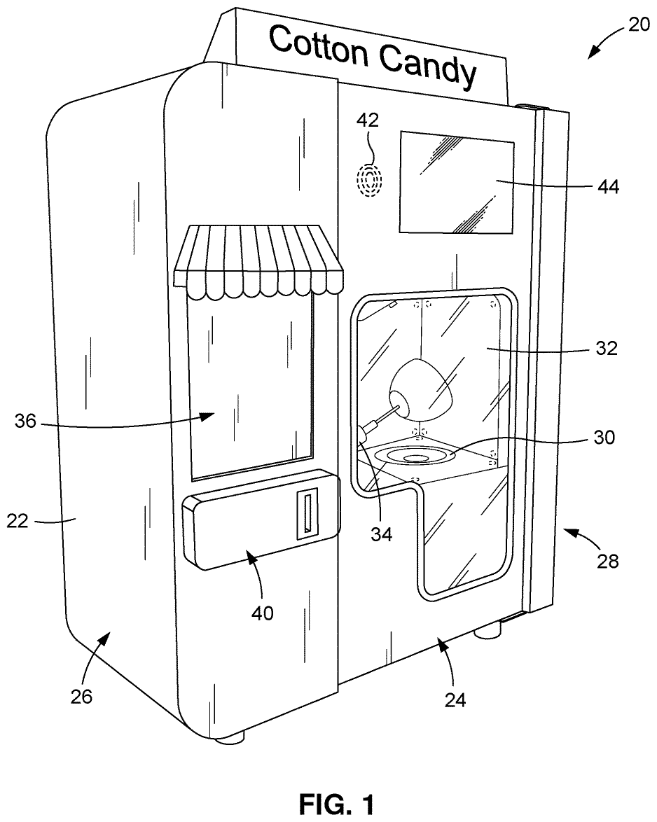

FIG. 1 illustrates one embodiment of a candy floss machine 20 in accordance with the invention. As illustrated, the candy floss machine 20 may include a housing 22, such as for containing and supporting various elements of the machine 20. The housing 22 may have various shapes and sizes. As illustrated, the housing 22 may have a front 24, an opposing rear (not visible), opposing first and second sides 26,28, and a top and opposing bottom (not visible).

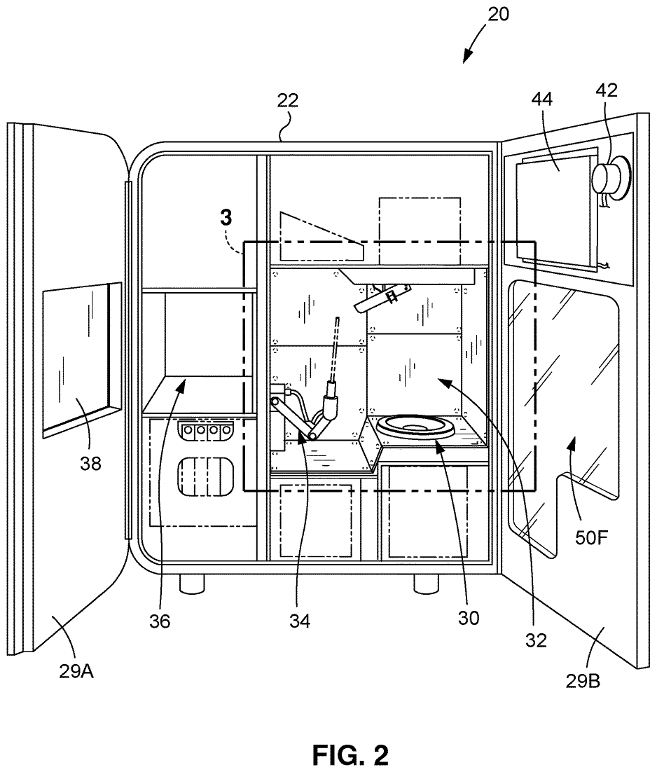

As better illustrated in FIG. 2, the housing 22 may generally define one or more interior areas, as described in more detail below. The interior area(s) may be accessed by one or more doors or panels. For example, as illustrated, one or more doors 29A, B may be located at the front 24 and be moved between open and closed positions for selectively accessing interior portions of the housing 22. Additional doors or panels might be provided at the rear and/or sides 26,28 of the housing 22.

Importantly, the candy floss machine 20 includes a candy floss processor 30, such as is well known in the art. As is known, such a processor generally includes one or more sources of sugar, a heater or burner for heating an amount of sugar, a screen or nozzles through which the heated sugar passes to create candy floss or strands, and in some cases, and a blower for generating an air flow directs the candy floss or strands. This processor may be located in the interior of the housing 22 and is configured to dispense candy floss into a generally enclosed processing area 32. This processing area 32 is described in more detail below.

In one embodiment, candy floss is collected in the processing area 32, such as onto a stick or paper tube which is supported by a movable arm 34. This arm 34 is preferably movable from a first position in which it extends into the processing area 32 to a second position in which it extends into a dispensing area 36 (see FIG. 2). The dispensing area 36 may comprise another interior area of the housing 22, and may include a panel 38 located at the front 24 of the housing (such as in one of the doors 29A), which panel can be opened to allow a user to obtain the generated candy floss from the dispensing area 26 to remove it from the housing 22 (such as by grabbing the stick or tube which is supporting the candy floss and removing it from the arm 34).

Of course, the candy floss machine 20 may include various other elements, including for rendering the candy floss machine “self-service.” For example, the candy floss machine 20 may include a payment mechanism 40, such as an NFC reader, card reader, currency reader or other means for receiving information regarding payment or for receiving and processing a payment element. This payment mechanism 40 may communicate, such as via a communication interface, to one or more third party systems, such as external bank card processing systems or the like.

The candy floss machine 20 may include other elements, such as an audio output device (such as a speaker 42) for outputting sound including music, spoken audible instructions and the like, as well as one or more video display devices 44, such as for displaying graphical information. The candy floss machine 20 may include one or more user input device, such as buttons, a touch-screen or the like. For example, a touch-screen may be associated with one or more of the video displays, such as for allowing a user to make touch input in relation to one or more graphically displayed elements.

Although not illustrated, operation of the candy floss machine 20 may be controlled by a controller. The controller may be configured to execute machine-readable code which is instantiated in non-transitory form in an associated memory. The controller may be configured to receive information, such as inputs, from the various elements of the machine, and generate outputs, such as instructions. Preferably, the various elements of the candy floss machine 20, including the controller, enable self-service operation of the candy floss machine 20 (e.g. enable operation solely by a user without requiring an attendant or operator).

In general, in use, a user may make a selection of a desired candy floss product. For example, a user might select from different flavors, colors or shapes for the candy floss product. This selection may be made by an input to a touch-screen or other input device, such as in relation to displayed graphical elements (images of products, menu elements, etc.). The user may also provide payment for their selection, such as using the payment mechanism 40. The user's selection and confirmation of payment from the payment mechanism 40 may be provided to the controller, causing the controller to instruct the candy floss processor 30 to generate the selected candy floss product. This may include causing the a sugar dispenser to dispense sugar from sugar receptacles to the burner and through the screen or nozzle, causing the arm 34 (such as via instruction to one or more motors which move the arm) to move into the processing area 32, and causing the blower to blow air to direct the candy floss, such as onto a stick or paper tube held by the arm. Once the candy floss has been generated, the controller may instruct the arm 34 to move the candy floss product to the dispensing area 36 and open the door or panel to allow the user to retrieve the product.

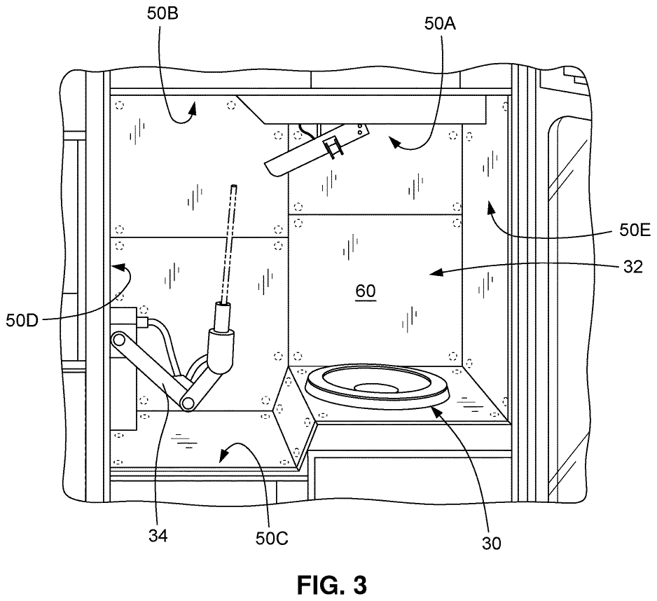

As indicated above, as one aspect of the candy floss machine 20, generated candy floss is directed into a processing area 32, such as for collection. As shown in FIGS. 2 and 3, the processing area 32 preferably comprises a compartment which is located in and defined or supported by the housing 22. For example, the processing area 32 may be defined by one or more walls, such as a rear wall 50A, a top wall 50B and an opposing bottom wall 50C, first and second side walls 50D and 50E, and a front wall 50F (and/or other walls, depending on the configuration, including shape, of the processing area). As illustrated in FIG. 2, the front wall 50F may comprise a portion of one of the doors 29B of the housing 22. A portion of this front wall 50F may comprise a transparent panel (such as made of glass) to allow viewing into the processing area 32. The other walls 50A-50E may be made of metal, such as stainless steel or the like, such as from panels which are welded, bent or the like, to form the processing area 32.

As indicated in the Background above, a problem with such a processing area 32 is that when candy floss is generated and dispensed into the processing area 32, not all of it is captured (such as on the stick or tube held by the arm 34). Instead, some of the candy floss lands on the walls of the processing area 32, thus requiring the walls to be cleaned from time to time.

In one embodiment of the invention, as illustrated in FIG. 3, one or more panel members 60 are removably connected to the candy floss machine 20, particularly within the processing area 32. In a preferred embodiment, the panel members 60 cover the walls 50A-E of the processing area 32 (and may cover the front wall 50F in some embodiments, although in the preferred embodiment, the front wall remains defined by the transparent panel of the door 29B).

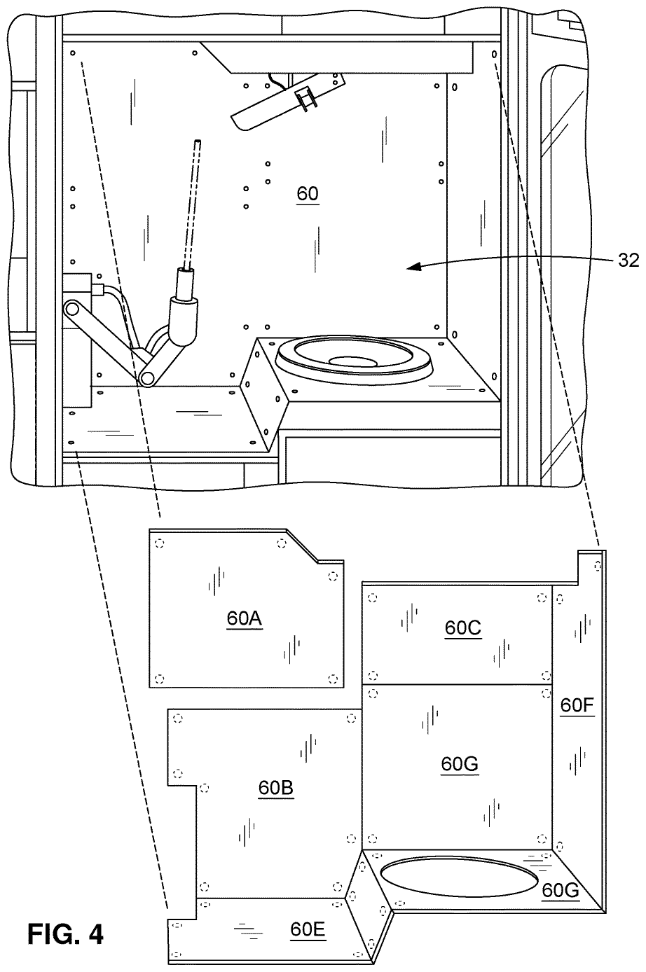

One embodiment of an arrangement of the panel members is illustrated in FIG. 4. As illustrated, a plurality of panel members 60A-G is removably connected to the walls 50A-E of the processing area. These panel members 60A-G are preferably durable, bio-resistant, food-safe (safe for the association of edible products thereon) and cleanable (such as dish-washer safe). For example, the panel members 60A-G may comprise a melamine material or be a body coated with such a material. The panel elements might otherwise comprise a polymer material, a ceramic material or other materials.

In one embodiment, the panel members 60A-G are configured to be selectively connectable to and disconnectable or removable from, the candy floss machine 20. For example, in one embodiment, a means for removably connecting the panel members 60A-G to the walls 50A-E is provided. When the walls 50A-E are constructed from a metallic material, this means may comprise one or more magnets which are located at a rear of each panel element. In other embodiments, the means may comprise connectors, such as one or more mating male and female connectors which are associated with the panel members 60A-G and the walls 50A-E. For example, the connectors may comprise male connectors which extend from the rear of each panel element into engagement with a mating female aperture in the walls.

Of course, the number of panel members 60A-G, as well as their shape and size, may vary, such as depending upon the shape of the processing area 32. In general, it is desirable for the panel members to not be so large that they are difficult (such as too heavy or too great in dimension) to attach and remove (including, where access to the processing area 32 is accessible via a door or panel, the panel members may be moved into and out of the processing area 32 via the opening created when the door or panel, such as the second door 29B, is open), and transport and wash. On the other hand, it is desirable to limit the number of individual panel members that have to be attached and removed. Thus, while seven panels are shown in the exemplary embodiment illustrated in FIG. 4, the number of panels may be greater or lesser in number.

In one embodiment, in order to eliminate seams between the panel members 60A-G when they are located in the processing area, the edges of the panel members may include slots and mating tabs, whereby a portion of one panel member interlocks or overlaps with another, thus reducing the probability of candy floss penetrating between two panel members to the wall(s) of the processing area. In one preferred embodiment, at least one edge of one panel may be designed to overlap the edge of another panel, so that the seam between the panels is covered in order to inhibit the collection of candy floss in the seams between the panels. For example, the panels may be designed so that at each mating edge, one of the panels has an outward extension at an outer surface thereof, that extension extending past the main edge of the panel. In use, that extension extends past the seam between mating or adjacent panels, with the extension located over the outer surface of the adjacent panel.

In use, the panel members 60A-G are preferably attached to the candy floss machine 20, such as by attaching them to the walls 50A-E, in order to cover the interior of the processing area 32. When the candy floss machine 20 is used, any candy floss which is not collected is then directed onto the removable panel members 60A-G. In one embodiment, a means may be provided which aids the user in identifying the location and/or sequence of placement of the panels. For example, the panels may bear numbers which correspond to numbers (or other designators) which are located on the walls. The numbers on the walls may not only be used to identify the location for each corresponding panel, but the sequence of panel placement (such as panel 1, then panel 2, then panel 3, etc.) These designations might be printed on the panels and walls, be embossed or formed therein, etc. In other embodiments, the designations might identify relative panel location, such as designations at each edge which are matched to corresponding designators on the edge of panel.

An operator may service the panel members 60A-G by disconnecting them from the candy floss machine 20, such as by disconnecting them from the walls 50A-E of the processing area 32. The operator may then clean the panels, such as in a dishwasher (or other cleaning mechanism, including where such panel members may be washed, sterilized, etc.), and then reattach them for later operation of the candy floss machine. In this manner, the processing area 32 of the candy floss machine 20 can easily and thoroughly be cleaned, solving this problem in the prior art.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A candy floss machine comprising:
a housing;
a candy floss processor;
a candy floss processing area into which candy floss is dispensed by said candy floss processor, said processing area defined by one or more walls;
a candy floss dispensing area; and
a plurality of cleanable panel members removably connected to the one or more walls of the processing area.

2. The candy floss machine in accordance with claim 1, wherein said one or more walls are metallic and said plurality of cleanable panel members are removably connected thereto with one or more magnets.

3. The candy floss machine in accordance with claim 1, wherein said plurality of cleanable panel members comprise melamine panels.

4. The candy floss machine in accordance with claim 1, wherein said members substantially cover said one or more walls.

5. The candy floss machine in accordance with claim 1, wherein said housing comprises a door which is movable between an open and a closed position and selectively provides access to said candy floss processing area and wherein said panel members are all sized to be removed from said candy floss processing area from said housing when said door is in an open position.

6. The candy floss machine in accordance with claim 5, wherein at least a portion of said door defines at least one of said one or more walls of said candy floss processing area.

7. The candy floss machine in accordance with claim 6, wherein said panel members are not associated with said portion of said door.

8. The candy floss machine in accordance with claim 1, wherein at least a first of said panel members has at least one edge which overlaps an edge of an adjacent second of said panel members when said first and second panel members are connected to the one or more walls.

9. The candy floss machine in accordance with claim 1, wherein said one or more panel members are dish-washer safe.

10. The candy floss machine in accordance with claim 1, wherein said one or more panel members have a ceramic front face.

11. The candy floss machine in accordance with claim 1, wherein said one or more panel members are generally planar, have a front face and an opposing rear face and a peripheral edge, and wherein said rear face of each of said panel members faces said wall of said one or more walls to which said panel member is mounted.

12. A method of servicing a candy floss machine comprising the steps of:
disconnecting a plurality of cleanable panel members extending over one or more walls of a processing area of the candy floss machine;
removing the plurality of cleanable panel members from the candy floss machine; and
washing said plurality of cleanable panel members.

13. The method in accordance with claim 12, wherein said plurality of cleanable panel members are connected to said walls with one or more magnets and said step of disconnecting comprises disengaging said one or more magnets from said one or more walls.

14. The method in accordance with claim 12, further comprising the step of opening a door providing access to said process area and wherein said step of removing comprises passing said plurality of cleanable panel members through an opening created by said opening of said door.

15. The method in accordance with claim 13, further comprising the step of re-connecting said plurality of cleanable panel members to said one or more walls of said processing area.

16. The method in accordance with claim 15, wherein said step of re-connecting comprises connecting said plurality of cleanable panel members with one or more fasteners.

17. The method in accordance with claim 16, wherein at least one of said one or more fasteners comprises a magnet.
